(19) United States
(12) Patent Application Publication
(10) Pub. No.: US 2026/0164251 A1
(43) Pub. Date: Jun. 11, 2026

(54) PREDICTIVE CROSSTALK MITIGATION

(71) Applicant: MOTOROLA SOLUTIONS, INC., Chicago, IL (US)

(72) Inventors: Kah Khoon Khoo, Butterworth (MY); Boon Kheng Hooi, Gelugor (MY); Wai Mun Lee, Ipoh (MY); Alexander Oon, Bayan Lepas (MY); Jing Wen Por, Paya Terubong (MY)

(21) Appl. No.: 18/974,538

(22) Filed: Dec. 9, 2024

(51) Int. Cl. H04W 16/14; H04W 64/00

(52) U.S. Cl. CPC H04W 16/14; H04W 64/00

(57) ABSTRACT

Devices, systems, and methods are disclosed. Examples provide a system for mitigating radio crosstalk. The system includes an electronic processor that receives, from a first radio that transmits radio signals at a first operating frequency, a location of the first radio and a list of spurious frequencies of the first radio. The electronic processor receives, from a second radio configured to receive radio signals at a second operating frequency different from the first operating frequency, a location of the second radio and an indication of the second operating frequency. In response to determining that the second operating frequency is included in the list of spurious frequencies and that the first radio is within the threshold distance of the second radio, the electronic processor generates a command to modify a configuration of a selected radio of the first radio or the second radio, and transmits the command to the selected radio.

### BACKGROUND

Examples herein relate to mitigating crosstalk between radio communication devices.

### BRIEF DESCRIPTION OF THE DRAWINGS

FIG. 1 illustrates a radio communication system, according to some examples.

FIG. 2 schematically illustrates a radio device, according to some examples.

FIG. 3 schematically illustrates a radio device, according to some examples.

FIG. 4 schematically illustrates a crosstalk mitigation server, according to some examples.

FIG. 5 is a flowchart of a method for mitigating crosstalk in a radio communication system, according to some examples.

FIG. 6 is a flowchart of a method for reverting a crosstalk mitigation measure, according to some examples.

Skilled artisans will appreciate that elements in the figures are illustrated for simplicity and clarity and have not necessarily been drawn to scale. For example, the dimensions of some of the elements in the figures may be exaggerated relative to other elements to help improve understanding of examples of the present disclosure.

The system, apparatus, and method components have been represented where appropriate by conventional symbols in the drawings, showing only those specific details that are pertinent to understanding the examples of the present disclosure so as not to obscure the disclosure with details that will be readily apparent to those of ordinary skill in the art having the benefit of the description herein.

### DETAILED DESCRIPTION

Radio or wireless communication systems are commonplace and used in various ways and systems. For example, radio communication systems are used in public safety and emergency services (for example, by first responders). Radio communication systems are also used in commercial and industrial operations. Generally, wireless communication occur between various devices across different frequencies and channels. As the demand for radio communication grows, so does the complexity of managing multiple radio devices operating in close proximity to one another.

One persistent challenge in radio communication systems is the phenomenon known as crosstalk. Crosstalk occurs when a signal transmitted on one circuit or channel creates an undesired effect in another circuit or channel. In the context of radio communication, this can manifest as a receiver radio device picking up signals from a transmitter radio device that is not operating on the same frequency as the receiver. This interference can significantly impact the performance and reliability of radio communications, particularly when devices are in close proximity to each other.

The risk of crosstalk is often heightened in scenarios where multiple radio devices are operating in densely populated areas or within confined spaces. As the distance between transmitter and receiver radio devices decreases, the likelihood of crosstalk increases, potentially compromising the integrity of communications. This is particularly problematic in mission-critical applications where clear and uninterrupted communication is essential.

Various factors contribute to the occurrence of crosstalk in radio systems. One common source is frequency spur, which can be generated by components within the radio devices themselves, such as synthesizers. These spurs, including fractional-N spurs and reference spurs, can create unwanted signals that interfere with nearby receivers. While shielding and proper layout techniques are often employed to mitigate these issues, they may not completely eliminate the problem.

Addressing crosstalk in radio communication systems has traditionally involved reactive approaches, such as manual frequency adjustments or physical separation of devices. However, these methods can be time-consuming, impractical in dynamic environments, and may not always provide optimal solutions. As radio communication systems continue to evolve and become more complex, there is a growing need for more sophisticated and proactive approaches to managing and mitigating crosstalk.

The challenges posed by crosstalk in radio communication systems underscore the importance of developing innovative solutions that can predict and prevent interference before it occurs. Such advancements could significantly enhance the reliability, efficiency, and overall performance of radio communications across various applications and industries. One example provides a system for mitigating radio crosstalk. The system includes an electronic processor configured to: receive, from a first radio configured to transmit radio signals at a first operating frequency, a location of the first radio and a list of spurious frequencies associated with the first radio, receive, from a second radio configured to receive radio signals at a second operating frequency different from the first operating frequency, a location of the second radio and an indication of the second operating frequency, determine whether the second operating frequency is included in the list of spurious frequencies associated with the first radio, determine whether the first radio is within a threshold distance of the second radio, in response to determining that the second operating frequency is included in the list of spurious frequencies and that the first radio is within the threshold distance of the second radio, generate a command to modify a configuration of a selected radio of the first radio or the second radio, and transmit the command to the selected radio.

In some aspects, the electronic processor is configured to generate a command to modify a phase locked loop (PLL) configuration of a selected radio of the first radio or the second radio.

In some aspects, the command to modify the configuration of the selected radio includes a command to modify at least one selected from a group consisting of a clock divider of the selected radio, a spur killer setting of the selected radio, a digital signal processing (DSP) filter of the selected radio, an attenuation level of the selected radio, a squelch level of the selected radio.

In some aspects, the list of spurious frequencies associated with the first radio includes a list of divider spurious frequencies and a list of reference spurious frequencies, and the electronic processor is configured to determine whether the second operating frequency is included in the list of divider spurious frequencies or the list of reference spurious frequencies, and generate the command to modify the configuration of the selected radio based on the determination of whether the second operating frequency is included in the list of divider spurious frequencies or the list of reference spurious frequencies.

In some aspects, the second operating frequency is included in the list of divider spurious frequencies, and the electronic processor is configured to generate the command to modify a clock divider of the first radio or a spur killer setting of the first radio.

In some aspects, the second operating frequency is included in the list of reference spurious frequencies, and the electronic processor is configured to generate the command to modify a clock divider of the first radio or a digital signal processing (DSP) filter of the second radio.

In some aspects, the electronic processor is further configured to receive, from the first radio, an updated location of the first radio, receive, from the second radio, an updated location of the second radio, in response to receiving the updated locations of the first radio and the second radio, determine whether the first radio is within the threshold distance of the second radio, and in response to determining that the first radio is not within the threshold distance of the second radio, generate a second command to revert the configuration of the selected radio to a default state, and transmit the second command to the selected radio.

In some aspects, the second radio is configured to transmit, at the second operating frequency, radio signals to a third radio different from the first radio.

In some aspects, the electronic processor is a cloud-based electronic processor.

In some aspects, the electronic processor is communicatively connected to the first radio and the second radio over a broadband connection.

Another example provides a method for mitigating radio crosstalk. The method includes: receiving, from a first radio configured to transmit radio signals at a first operating frequency, a location of the first radio and a list of spurious frequencies associated with the first radio; receiving, from a second radio configured to receive radio signals at a second operating frequency different from the first operating frequency, a location of the second radio and an indication of the second operating frequency; determining whether the second operating frequency is included in the list of spurious frequencies associated with the first radio; determining whether the first radio is within a threshold distance of the second radio; in response to determining that the second operating frequency is included in the list of spurious frequencies and that the first radio is within the threshold distance of the second radio, generating a command to modify a configuration of a selected radio of the first radio or the second radio; and transmitting the command to the selected radio.

In some aspects, the command is a command to modify a phase locked loop (PLL) configuration of the selected radio.

In some aspects, the command to modify the configuration of the selected radio includes a command to modify at least one selected from a group consisting of a clock divider of the selected radio, a spur killer setting of the selected radio, a digital signal processing (DSP) filter of the selected radio, an attenuation level of the selected radio, a squelch level of the selected radio.

In some aspects, the list of spurious frequencies associated with the first radio includes a list of divider spurious frequencies and a list of reference spurious frequencies, and the method further includes: determining whether the second operating frequency is included in the list of divider spurious frequencies or the list of reference spurious frequencies; and generating the command to modify the configuration of the selected radio based on the determination of whether the second operating frequency is included in the list of divider spurious frequencies or the list of reference spurious frequencies.

In some aspects, the second operating frequency is included in the list of divider spurious frequencies, and the command is a command to modify a clock divider of the first radio or a spur killer setting of the first radio.

In some aspects, the second operating frequency is included in the list of reference spurious frequencies, and the command is a command to modify a clock divider of the first radio or a digital signal processing (DSP) filter of the second radio.

In some aspects, the method further includes: receiving, from the first radio, an updated location of the first radio; receiving, from the second radio, an updated location of the second radio; in response to receiving the updated locations of the first radio and the second radio, determining whether the first radio is within the threshold distance of the second radio; in response to determining that the first radio is not within the threshold distance of the second radio, generating a second command to revert the configuration of the selected radio to a default state; and transmitting the second command to the selected radio.

Another example provides a non-transitory computer readable medium storing instructions that, when executed by an electronic processor, cause the electronic processor to perform a set of operations including: receiving, from a first radio configured to transmit radio signals at a first operating frequency, a location of the first radio and a list of spurious frequencies associated with the first radio; receiving, from a second radio configured to receive radio signals at a second operating frequency different from the first operating frequency, a location of the second radio and an indication of the second operating frequency; determining whether the second operating frequency is included in the list of spurious frequencies associated with the first radio; determining whether the first radio is within a threshold distance of the second radio; in response to determining that the second operating frequency is included in the list of spurious frequencies and that the first radio is within the threshold distance of the second radio, generating a command to modify a configuration of a selected radio of the first radio or the second radio; and transmitting the command to the selected radio.

In some aspects, the command is a command to modify a phase locked loop (PLL) configuration of the selected radio.

In some aspects, the set of operations further include: receiving, from the first radio, an updated location of the first radio; receiving, from the second radio, an updated location of the second radio; in response to receiving the updated locations of the first radio and the second radio, determining whether the first radio is within the threshold distance of the second radio; in response to determining that the first radio is not within the threshold distance of the second radio, generating a second command to revert the configuration of the selected radio to a default state; and transmitting the second command to the selected radio.

Examples are herein described with reference to flowchart illustrations and/or block diagrams of methods, apparatus (systems) and computer program products according to examples. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some examples, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or example discussed in this specification can be implemented or combined with any part of any other aspect or example discussed in this specification.

Further advantages and features consistent with this disclosure will be set forth in the following detailed description, with reference to the figures.

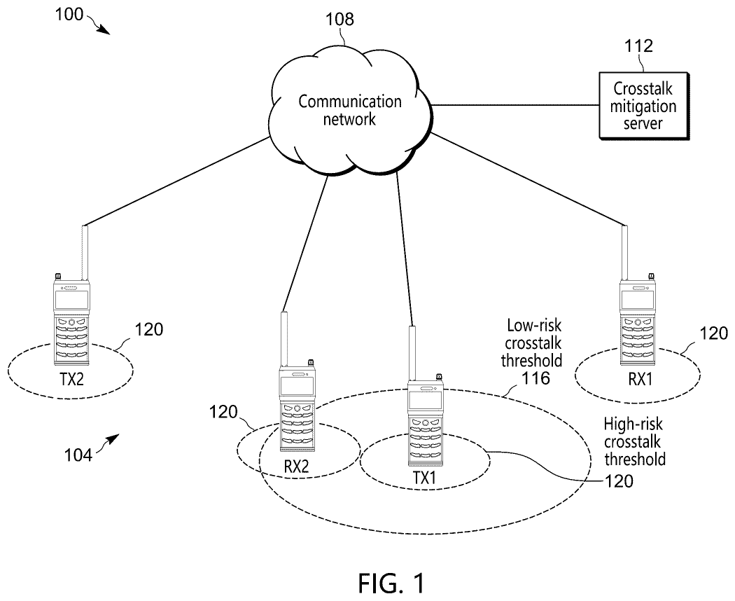

Referring now to the drawings, FIG. 1 illustrates a radio communication system 100, according to some examples. The communication system 100 includes a plurality of radios 104 configured to operate in the radio communication system 100. In the illustrated example, the plurality of radios 104 includes a first transmitting radio TX1 configured to operate according to a first operational frequency to transmit signals to a first receiving radio RX1 over a communication network 108. In the illustrated example, the plurality of radios 104 also includes a second transmitting radio TX2 configured to operate according to a second operational frequency to transmit signals to a second receiving radio RX2 over the communication network 108. For simplicity, the radio communication system 100 is illustrated in FIG. 1 as having four radios 104 operating therein. However, the radio communication system 100 may include more than four radios or less than four radios.

While described herein for simplicity as transmitting radios or receiving radios, each of the plurality of radios 104 may be operable to both transmit and receive radio signals over the communication network 108. In the example illustrated in FIG. 1, each of the plurality of radios 104 are illustrated as mobile radios 104. However, in some instances, one or more of the radios 104 are stationary radio device. In the examples described herein, at least the first transmitting radio TX1 and/or the second receiving radio RX2 are mobile radios. Accordingly, crosstalk mitigation methods are generally described herein with respect to the first transmitting radio TX1 and the second receiving radio RX2. However, the crosstalk mitigation methods may be performed with respect to other radios 104 in the system 100. The first transmitting radio TX1 operates at a different frequency than the second receiver radio RX2. For example, the first transmitting radio TX1 may be configured for a different channel or talkgroup than the second receiver radio RX2 such that the second receiver radio RX2 is not an intended recipient of radio transmissions from the first transmitting radio TX1.

The radios 104 may transmit and receive radio according to one or more suitable communication protocols. For example, the radios 104 may operate according the Project 25 (P25) standard defined by the Association of Public Safety Communications Officials International (APCO), the TETRA standard defined by the European Telecommunication Standards Institute (ETSI), the Digital Private Mobile Radio (dPMR) standard also defined by the ETSI, the Digital Mobile Radio (DMR) standard also defined by the ESI, LTE-Advanced or LTE-Advanced Pro compliant with, for example, the 3GPP TS 36 specification series, or the 5G (including a network architecture compliant with, for example, the 3GPP TS 23 specification series and a new radio (NR) air interface compliant with the 3GPP TS 38 specification series) standard, among other possibilities.

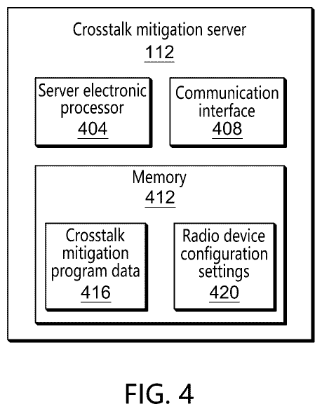

The communication network 108 illustrated in FIG. 1 at least includes a radio-frequency (RF) network 108 (e.g., a land mobile radio (LMR) network), and may include additional communication networks. For example, the communication network 108 may further include a broadband network or other suitable communication network. A crosstalk mitigation server 112, described in greater detail below with respect to FIG. 4, is communicatively connected to the radios 104 over the communication network 108 (e.g., over an LMR network, a broadband network, and/or the like).

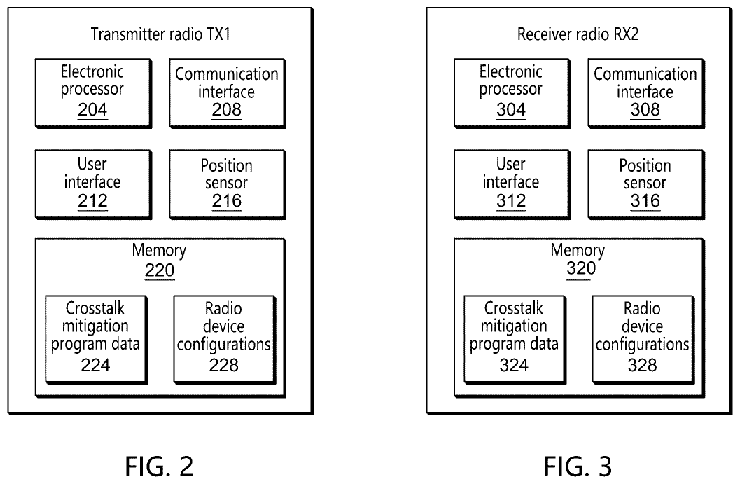

FIG. 2 schematically illustrates the first transmitter radio TX1, according to some examples. In the example illustrated in FIG. 2, the first transmitter radio TX1 includes an electronic processor 204 communicatively connected to a communication interface 208, a user interface 212, a position sensor 216, and a memory 220. The communication interface 208 includes, for example, one or more RF transmitter/receiver systems for transmitting and receiving signals over the communication network 108 (e.g., to other radios 104 and/or to the crosstalk mitigation server 112).

The user interface 212 may include a microphone for converting audio (e.g., voice from a user of the first transmitter radio TX1 to electrical signals. Those signals or processed versions of them may be transmitted, using the communication interface 208, to the first receiving radio RX1. The user interface 212 may also include a speaker for outputting, to the user, sound data received via the communication interface 208. The user interface 212 may further include one or more buttons, knobs, dials, or the like for controlling operation of the first transmitter radio TX1 (e.g., a push-to-talk button, a volume dial, etc.).

The position sensor 216 includes, for example, a global positioning system (GPS) sensor configured to detect a location of the first transmitter radio TX1 and output the detected location to the electronic processor 204.

The memory 220 stores information related to operation of the transmitter radio TX1 (e.g., crosstalk mitigation program data 224) and software or program instructions that, when executed by the electronic processor 204, cause the electronic processor 204 to perform, among other things, crosstalk mitigation functions (that are described in more detail below). The memory 220 may further store radio device configurations 228 (e.g., phase locked loop (PLL) configurations or other radio configurations) for operating the transmitter radio device TX1. For example, PLL device configurations may include a clock divider setting, a spur killer or targeted spur attenuation setting, a digital signal processing (DSP) filter setting, an attenuation level, a squelch level, or the like. Other radio configurations include, for example, a clock source configuration.

FIG. 3 schematically illustrates the second receiver radio RX2, according to some examples. In the example illustrated in FIG. 3, the second receiver radio RX2 includes an electronic processor 304 communicatively connected to a communication interface 308, a user interface 312, a position sensor 316, and a memory 320. The communication interface 308 includes, for example, one or more RF transmitter/receiver systems for transmitting and receiving signals over the communication network 108 (e.g., to and from other radios 104 and/or to and from the crosstalk mitigation server 112).

The user interface 312 may include a microphone for converting audio (for example, voice) from a user of second receiver radio RX2 to electrical signals. Those signals or processed versions of them may be transmitted, using the communication interface 308, to another radio 104. The user interface 312 may also include a speaker for outputting, to the user, sound data received via the communication interface 308 (e.g., from the second transmitter radio TX2). The user interface 312 may further include one or more buttons, knobs, dials, or the like for controlling operation of the second receiver radio RX2 (e.g., a push-to-talk button, a volume dial, etc.).

The position sensor 316 includes, for example, a global positioning system (GPS) sensor configured to detect a location of the second receiver radio RX2 and output the detected location to the electronic processor 304.

The memory 320 stores information related to operation of the second receiver radio RX2 (e.g., crosstalk mitigation program data 324) and software or program instructions that, when executed by the electronic processor 304, cause the electronic processor 304 to perform, among other things, crosstalk mitigation functions (described herein). The memory 320 may also store radio device configurations 328 (e.g., phase locked loop (PLL) configurations or other radio configurations) for operating the second receiver radio RX2. For example, PLL device configurations may include a clock divider setting, a spur killer or targeted spur attenuation setting, a digital signal processing (DSP) filter setting, an attenuation level, a squelch level, or the like.

FIG. 4 schematically illustrates the crosstalk mitigation server 112, according to some examples. The crosstalk mitigation server 112 is, for example, a cloud-based server 112. In the example illustrated in FIG. 4, the crosstalk mitigation server 112 includes a server electronic processor 404 communicatively connected to a server communication interface 408, and a server memory 412. The server communication interface 408 communication connects the server 112 to, among other things, each of the plurality of radios 104 over the communication network 108.

The server memory 412 stores information related to operation of the crosstalk mitigation server 112 (e.g., crosstalk mitigation program data 416) and software or program instructions that, when executed by the server electronic processor 404, cause the electronic processor 404 to perform, among other things, the methods described herein. The server memory 412 may also store radio device configuration settings 420 associated with some or all of the radios 104 operating in the system 100. For example, the server memory 412 may store the PLL configurations of the radios 104, talk group or channel configurations, operating frequencies, or other configurable settings of the radios 104.

The crosstalk mitigation server 112 may include additional components than those illustrated in FIG. 4. The crosstalk mitigation server 112 may perform additional functions than those described herein. In some instances, the crosstalk mitigation server 112 is included as part of an LMR core network.

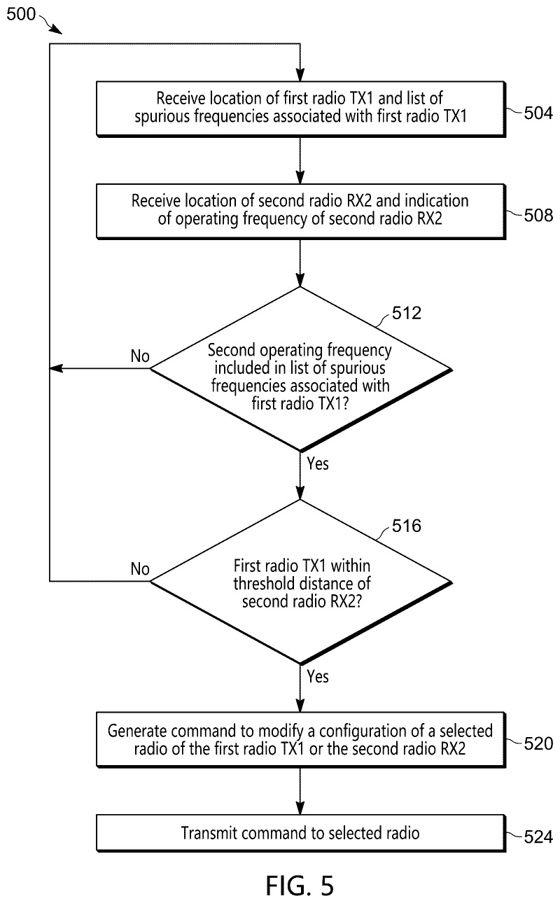

FIG. 5 illustrates a method 500 for mitigating crosstalk between, for example, the first transmitting radio TX1 and a nearby radio, for example the second receiving radio RX2. The method 500 is executed by, for example, the server electronic processor 404 in conjunction with other components of the crosstalk mitigation server 112. By way of example, the crosstalk mitigation method 500 is described as being performed with respect to the first transmitting radio TX1 and the second transmitting radio RX2. However, it should be understood that the crosstalk mitigation method 500 may be performed with respect to other radios 104 in the system 100 in lieu of, or in addition to, the first transmitting radio TX1 and the second receiving radio RX2. Accordingly, for simplicity, the first transmitting radio TX1 is described with reference to FIG. 5 as the first radio TX1 and the second receiving radio RX2 is described with reference to FIG. 5 as the second radio RX2. The first radio TX1 is, for example, a radio having a risk of interfering with (e.g., causing crosstalk with) the second radio RX2.

The server electronic processor 404 receives, from the first radio TX1, a location of the first radio TX1 and a list of spurious frequencies associated with the first radio TX1 (at block 504). For example, the first radio TX1 may periodically transmit its location (e.g., based on an output of the position sensor 216) to the crosstalk mitigation server 112. In some instances, the first radio TX1 transmits its location to the crosstalk mitigation server 112 in response to the server electronic processor 404 of the crosstalk mitigation server 112 transmitting a request for the location of the first radio TX1. In some instances, the first radio TX1 transmits its location to the crosstalk mitigation server 112 in response to moving a threshold distance. Similarly, the first radio TX1 may transmit a list of spurious frequencies to the crosstalk mitigation server 112 periodically, in response to receiving a request from the crosstalk mitigation server 112, and/or in response to another trigger.

The first radio TX1 is configured to operate at a first operating frequency, and the list of spurious frequencies received from the first radio indicate spurious frequencies associated with the first operating frequency. The list of spurious frequencies may include spurious frequencies caused by both divider spur and reference spur. For example, the list of spurious frequencies may include a first list indicating divider spurious frequencies and a second list indicating reference spurious frequencies. In some examples, the server electronic processor 404 also receives, from the first radio TX1, a separate indication of the first operating frequency of the first radio TX1. In other examples, an indication of the first operating frequency may be included in the list of spurious frequencies received from the first radio TX1.

The server electronic processor 404 receives, from the second radio RX2, a location of the second radio RX2 and an indication of the operating frequency of the second radio RX2 (at block 508). The second radio RX2 is a radio that is configured to transmit and/or receive signals at a second operating frequency that is different from the first operating frequency at which the first radio TX1 transmits signals. In some examples, the indication of the operating frequency of the second radio RX2 (e.g., the second operating frequency) is included as part of a spurious frequency list received from and associated with the second transmitting radio RX2.

The second radio RX2 may transmit its location (e.g., based on an output of the position sensor 316) to the crosstalk mitigation server 112 periodically and/or in response to receiving a request from the server electronic processor 404 of the crosstalk mitigation server 112 for the location of the second radio RX2. In some instances, the second radio RX2 transmits its location to the crosstalk mitigation server 112 in response to moving a threshold distance. Similarly, the second radio RX2 may transmit the indication of the second operating frequency periodically, in response to receiving a request from the crosstalk mitigation server 112, and/or in response to another trigger.

In one example, the server electronic processor 404 determines whether the second operating frequency (e.g., the operating frequency of the second radio RX2) is included in the list of spurious frequencies associated with the first radio TX1 (at decision block 512). The server electronic processor 404 also determines whether the first radio TX1 is within a threshold distance (e.g., within the low-risk crosstalk threshold 116 illustrated in FIG. 1) of the second radio RX2 (at decision block 516). The threshold distance is a predefined distance such that, even when the first radio TX1 is within the threshold distance to the second radio RX2, there is a low risk of crosstalk between the first radio and the second radio TX2. In other words, the threshold distance is larger than a distance associated with a high risk of crosstalk (e.g., high-risk crosstalk threshold illustrated in FIG. 1). For example, the threshold distance may be 50 meters, 100 meters, 125 meters, or the like. In some instances, the threshold distance is selected by, for example, the server electronic processor 404 based on characteristics of the radios 104, for example the device configurations or the like.

In response to determining that the second operating frequency associated with the second radio RX2 is included in the list of spurious frequencies associated with the first radio TX1 (YES at decision block 512) and that the first radio TX1 is within the threshold distance of the second radio RX2 (YES at decision block 516), the server electronic processor 404 generates a command to modify a configuration of a selected radio of either the first transmitter radio TX1 or the second receiver radio RX2 (at block 520), and transmits the command to the selected radio (at block 524).

The command is, for example, a command to modify a PLL configuration of the selected radio, for example a clock divider of the selected radio, a spur killer setting of the selected radio, a DSP filter setting of the selected radio, an attenuation level of the selected radio, a squelch level of the selected radio, or a combination thereof. Reception of the command by the selected radio may modify the spurious frequencies of the selected radio or cause interfering transmissions to be filtered out such that the selected radio is still able to communicate as intended (e.g., without changing the base operating frequencies) and without experiencing crosstalk.

In some instances, the server electronic processor 404 generates the command to modify the configuration of a selected radio based on a cause of potential (e.g., predicted) crosstalk that is mitigated, for example a type of spur. The server electronic processor 404 may determine whether the second operating frequency is included in a list of divider spurious frequencies or the list of reference spurious frequencies (e.g., at decision block 512), and generate the command to modify the configuration of the selected radio based on the determination of whether the second operating frequency is included in a list of divider spurious frequencies or the list of reference spurious frequencies (e.g., at block 520).

When the cause of predicted crosstalk is the divider spur (e.g., fractional-N spur or 2× offset spur) of the first radio TX1, the server electronic processor 404 may generate a command to modify a clock divider or a spur attenuation (e.g., a spur killer setting) of the first radio TX1. When the cause of predicted crosstalk is the reference spur (e.g., caused by the reference clock) of the first radio TX1, the server electronic processor 404 may generate a command to modify a clock divider of the first radio TX1 or a command to modify a DSP filter setting of the second radio RX2.

Table 1 provides an example use case for the crosstalk mitigation method 500 for a first radio TX1 having a first operating frequency of 400 Megahertz (MHz) and a second radio RX2 having a second operating frequency of 402.4 MHz:

TABLE 1

| | | | TX1 | | | |
|---|---|---|---|---|---|---|
| | | TX1 | Reference | Reference | TX1 | RX2 |
| | Spur | Operating | Clock | Spur | Interferer | Operating |
| | Type | Frequency | Divider | Frequency | Frequency | Frequency |
| Without Crosstalk | Reference | 400 MHz | 16 | 38.4 MHz/ | 402.4 MHz | 402.4 MHz |
| Mitigation | Spur | | | 16 = 2.4 MHz | | |
| With Crosstalk | Reference | 400 MHz | 8 (modified | 38.4 MHz/ | 404.8 MHz | 402.4 MHz |
| Mitigation | Spur | | config.) | 8 = 4.8 MHz | | |

As exemplified in Table 1, without the crosstalk mitigation method, the first radio TX1 has a spurious frequency (e.g., an interferer frequency) of 402.4 MHz that is the same as the operating frequency of the second radio RX2. In the example provided, this spurious frequency is caused by the reference clock divider value of 8. As a result, transmissions from the first radio TX1 may cause crosstalk with the second radio RX2 that is not an intended recipient of the transmissions from the first radio TX1. In contrast, with the crosstalk mitigation method, the server electronic processor 404 generates a command to modify (e.g., reduce by a power of two) the reference clock divider value of the first radio TX1. As a result, the spurious frequency of the first radio TX1 is no longer an interferer frequency to the second radio RX2, and crosstalk with the second radio RX2 is prevented.

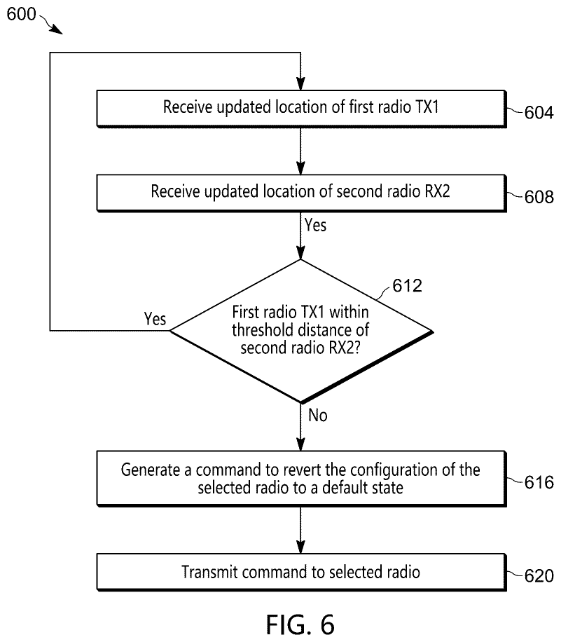

FIG. 6 illustrates a method 600 performed by, for example, the server electronic processor 404 in response to mitigating crosstalk in the system 100 (e.g., in response to transmitting the command to the selected radio at block 524 of the method 500). In this example, the server electronic processor 404 receives, from the first radio TX1, an updated location of the first radio TX1 (at block 604). The server electronic processor 404 may also receive, from the second radio RX2, an updated location of the second radio RX2 (at block 608). As described above, the first radio TX1 and/or the second radio RX2 may transmit a location to the server electronic processor 404 periodically, in response to receiving a request to do so, in response to moving a minimum distance, or the like.

In response to receiving the updated location of the first radio TX1 and/or the second radio RX2, the server electronic processor 404 determines whether the first radio TX1 is within (e.g., is still within) the threshold distance (e.g., the low-risk crosstalk threshold 116) of the second radio RX2 (at decision block 612). In response to determining that the first radio TX1 is no longer within the threshold distance of the second radio RX2 (NO at decision block 612), the server electronic processor 404 generates a command (e.g., a second command) to revert the configuration of the selected radio to a default state (at block 616), and transmits the second command to the selected radio (at block 620). The default state is, for example, the configuration (e.g., the PLL configuration) of the selected radio prior to transmission of the first crosstalk mitigation command at block 524 of the method 500. In this manner, the server electronic processor 404 determines when the risk of crosstalk is sufficiently low (e.g., the first radio TX1 is far enough away from the second radio RX2) that the crosstalk prevention measures are no longer needed.

As should be apparent from this detailed description above, the operations and functions of the electronic computing device are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., and cannot alter radio transmitter configurations, among other features and functions set forth herein).

In the foregoing specification, various examples have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if examples described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some examples may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an example can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

The terms “substantially,” “essentially,” “approximately,” “about” or any other version thereof, are defined as being close to as understood by one of ordinary skill in the art, and in one non-limiting example the term is defined to be within 10%, in another example within 5%, in another example within 1% and in another example within 0.5%. The term “one of,” without a more limiting modifier such as “only one of,” and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled,” “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A system for mitigating radio crosstalk, the system comprising:
an electronic processor configured to:
receive, from a first radio configured to transmit radio signals at a first operating frequency, a location of the first radio and a list of spurious frequencies associated with the first radio,
receive, from a second radio configured to receive radio signals at a second operating frequency different from the first operating frequency, a location of the second radio and an indication of the second operating frequency,
determine whether the second operating frequency is included in the list of spurious frequencies associated with the first radio,
determine whether the first radio is within a threshold distance of the second radio,
in response to determining that the second operating frequency is included in the list of spurious frequencies and that the first radio is within the threshold distance of the second radio, generate a command to modify a configuration of a selected radio of the first radio or the second radio, and
transmit the command to the selected radio.

2. The system of claim 1, wherein the electronic processor is configured to generate a command to modify a phase locked loop (PLL) configuration of a selected radio of the first radio or the second radio.

3. The system of claim 1, wherein the command to modify the configuration of the selected radio includes a command to modify at least one selected from a group consisting of a clock divider of the selected radio, a spur killer setting of the selected radio, a digital signal processing (DSP) filter of the selected radio, an attenuation level of the selected radio, a squelch level of the selected radio.

4. The system of claim 1, wherein the list of spurious frequencies associated with the first radio includes a list of divider spurious frequencies and a list of reference spurious frequencies, and the electronic processor is configured to
determine whether the second operating frequency is included in the list of divider spurious frequencies or the list of reference spurious frequencies, and
generate the command to modify the configuration of the selected radio based on the determination of whether the second operating frequency is included in the list of divider spurious frequencies or the list of reference spurious frequencies.

5. The system of claim 4, wherein the second operating frequency is included in the list of divider spurious frequencies, and the electronic processor is configured to generate the command to modify a clock divider of the first radio or a spur killer setting of the first radio.

6. The system of claim 4, wherein the second operating frequency is included in the list of reference spurious frequencies, and the electronic processor is configured to generate the command to modify a clock divider of the first radio or a digital signal processing (DSP) filter of the second radio.

7. The system of claim 1, wherein the electronic processor is further configured to
receive, from the first radio, an updated location of the first radio,
receive, from the second radio, an updated location of the second radio,
in response to receiving the updated locations of the first radio and the second radio, determine whether the first radio is within the threshold distance of the second radio, and
in response to determining that the first radio is not within the threshold distance of the second radio, generate a second command to revert the configuration of the selected radio to a default state, and
transmit the second command to the selected radio.

8. The system of claim 1, wherein the second radio is configured to transmit, at the second operating frequency, radio signals to a third radio different from the first radio.

9. The system of claim 1, wherein the electronic processor is a cloud-based electronic processor.

10. The system of claim 9, wherein the electronic processor is communicatively connected to the first radio and the second radio over a broadband connection.

11. A method for mitigating radio crosstalk, the method comprising:
receiving, from a first radio configured to transmit radio signals at a first operating frequency, a location of the first radio and a list of spurious frequencies associated with the first radio;
receiving, from a second radio configured to receive radio signals at a second operating frequency different from the first operating frequency, a location of the second radio and an indication of the second operating frequency;
determining whether the second operating frequency is included in the list of spurious frequencies associated with the first radio;
determining whether the first radio is within a threshold distance of the second radio;
in response to determining that the second operating frequency is included in the list of spurious frequencies and that the first radio is within the threshold distance of the second radio, generating a command to modify a configuration of a selected radio of the first radio or the second radio; and
transmitting the command to the selected radio.

12. The method of claim 11, wherein the command is a command to modify a phase locked loop (PLL) configuration of the selected radio.

13. The method of claim 11, wherein the command to modify the configuration of the selected radio includes a command to modify at least one selected from a group consisting of a clock divider of the selected radio, a spur killer setting of the selected radio, a digital signal processing (DSP) filter of the selected radio, an attenuation level of the selected radio, a squelch level of the selected radio.

14. The method of claim 11, wherein the list of spurious frequencies associated with the first radio includes a list of divider spurious frequencies and a list of reference spurious frequencies, and the method further comprises:
determining whether the second operating frequency is included in the list of divider spurious frequencies or the list of reference spurious frequencies; and
generating the command to modify the configuration of the selected radio based on the determination of whether the second operating frequency is included in the list of divider spurious frequencies or the list of reference spurious frequencies.

15. The method of claim 14, wherein the second operating frequency is included in the list of divider spurious frequencies, and the command is a command to modify a clock divider of the first radio or a spur killer setting of the first radio.

16. The method of claim 14, wherein the second operating frequency is included in the list of reference spurious frequencies, and the command is a command to modify a clock divider of the first radio or a digital signal processing (DSP) filter of the second radio.

17. The method of claim 11, further comprising:
receiving, from the first radio, an updated location of the first radio;
receiving, from the second radio, an updated location of the second radio;
in response to receiving the updated locations of the first radio and the second radio, determining whether the first radio is within the threshold distance of the second radio;
in response to determining that the first radio is not within the threshold distance of the second radio, generating a second command to revert the configuration of the selected radio to a default state; and
transmitting the second command to the selected radio.

18. A non-transitory computer readable medium storing instructions that, when executed by an electronic processor, cause the electronic processor to perform a set of operations comprising:
receiving, from a first radio configured to transmit radio signals at a first operating frequency, a location of the first radio and a list of spurious frequencies associated with the first radio;
receiving, from a second radio configured to receive radio signals at a second operating frequency different from the first operating frequency, a location of the second radio and an indication of the second operating frequency;
determining whether the second operating frequency is included in the list of spurious frequencies associated with the first radio;
determining whether the first radio is within a threshold distance of the second radio;
in response to determining that the second operating frequency is included in the list of spurious frequencies and that the first radio is within the threshold distance of the second radio, generating a command to modify a configuration of a selected radio of the first radio or the second radio; and
transmitting the command to the selected radio.

19. The non-transitory computer readable medium of claim 18, wherein the command is a command to modify a phase locked loop (PLL) configuration of the selected radio.

20. The non-transitory computer readable medium of claim 18, wherein the set of operations further comprise:
receiving, from the first radio, an updated location of the first radio;
receiving, from the second radio, an updated location of the second radio;
in response to receiving the updated locations of the first radio and the second radio, determining whether the first radio is within the threshold distance of the second radio;
in response to determining that the first radio is not within the threshold distance of the second radio, generating a second command to revert the configuration of the selected radio to a default state; and
transmitting the second command to the selected radio.
